(19) United States
(12) Patent Application Publication
(10) Pub. No.: US 2009/0081939 A1
(43) Pub. Date: Mar. 26, 2009

(54) Air conditioner for vehicle

(76) Inventor: Kenji Tsuneyoshi, Saitama-shi (JP)

Correspondence Address: WENDEROTH, LIND & PONACK, L.L.P., 2033 K STREET N. W., SUITE 800, WASHINGTON, DC, 20006-1021, US

(21) Appl. No.: 12/232,716

(22) Filed: Sep. 23, 2008

(30) Foreign Application Priority Data
Sep. 25, 2007 (JP) 2007-246415

(51) Int. Cl. B60H 3/00; B60H 1/00

(52) U.S. Cl. 454/156; 454/139

(57) ABSTRACT

An air conditioner for a vehicle includes a body which has a suction port including an inside air inlet and an outside air inlet and a blowout port, an intake door configured to close one of the inside air inlet and the outside air inlet, a fan configured to take inside or outside air from the suction port to send the taken inside or outside air through the blowout port to a vehicle room as an air-conditioned air, a component emitting device, the component emitting device generating and emitting air including a desired component in the body while the fan is driven to send the desired air to the vehicle room with the air-conditioned air, and a control device configured to close the outlet air inlet by the intake door while the component emitting device generates the desired component.

### CROSS REFERENCE TO RELATED APPLICATIONS

The present application is based on and claims priority from Japanese Application Number 2007-246416, filed on Sep. 26, 2007, the disclosure of which is hereby incorporated by reference herein in its entirety.

### BACKGROUND OF THE INVENTION

1. Field of the Invention

The present invention relates to an air conditioner for a vehicle, which has a function of blowing air containing a component, such as a desired or beneficial component for an occupant, for example, minus ion or negative ion.

2. Description of the Related Art

As a conventional air conditioner for a vehicle, for example, Japanese Patent Application Publication Number 2005-170325 discloses an air conditioner 11 for a vehicle (see FIG. 2 of the above document). The air conditioner 11 is configured to switch a suction port of a case 13 of the air conditioner between an inside air introducing mode and an outside air introducing mode by driving a switching door 25. Furthermore, the air conditioner 11 drives an air-blowing device 15 to take inside air or outside air into an inside of the case 13 from the suction port and then blow out the taken outside or inside air into a vehicle room of the vehicle as air-conditioned air from blowout ports 31, 33, 35.

In addition, the air conditioner 11 is provided with a component emitting device 43 in the case 13. The component emitting device 43 is configured to emit air including a desired or beneficial component for an occupant such as minus ion or negative ion during driving of the air-blowing device 15 and to blow out the air into the vehicle room with the air-conditioned air. Thereby, a comfortable environment can be provided to the occupant.

On the other hand, an air conditioner for a vehicle, which can provide a more comfortable environment to the occupant, has recently been required on the market. However, the conventional air conditioner can not sufficiently realize the above requirement.

### SUMMARY OF THE INVENTION

An object of the present invention is to provide an air conditioner for a vehicle, which can provide a more comfortable environment to an occupant by use of a desired or beneficial component for the occupant than the conventional air conditioner.

To achieve the above object, an air conditioner for a vehicle according to an embodiment of the present invention, which conditions air in a vehicle room of the vehicle by sending air-conditioned air to the vehicle room, includes a body which has a suction port including an inside air inlet and an outside air inlet and a blowout port, an intake door configured to close one of the inside air inlet and the outside air inlet, a fan configured to take into the body inside or outside air from the suction port in which the outside air inlet or the inside air inlet is closed and to send the taken inside or outside air through the blowout port to the vehicle room as the air-conditioned air, a component emitting device provided in the body, the component emitting device being configured to emit air including a desired component in the body while the fan is driven to send the emitted desired air to the vehicle room with the air-conditioned air, and a control device configured to close the outlet air inlet by the intake door while the component emitting device emits the air including the desired component.

### BRIEF DESCRIPTION OF THE DRAWINGS

FIG. 1 is a schematic side view in section illustrating a vehicle in which an air conditioner according to an embodiment of the present invention is used.

FIG. 2 is a schematic configuration diagram of an air conditioner according to an embodiment of the present invention

FIG. 3 is a flowchart illustrating control operations in an air conditioner according to an embodiment of the present invention.

FIG. 4 is a flowchart illustrating control operations of an air conditioner according to an embodiment of the present invention.

FIG. 5 is a flowchart illustrating control operations of an air conditioner according to an embodiment of the present invention.

### DETAILED DESCRIPTION OF THE PREFERRED EMBODIMENTS

Preferred embodiments of the present invention will be described in detail with reference to the accompanying drawings below.

### First Embodiment

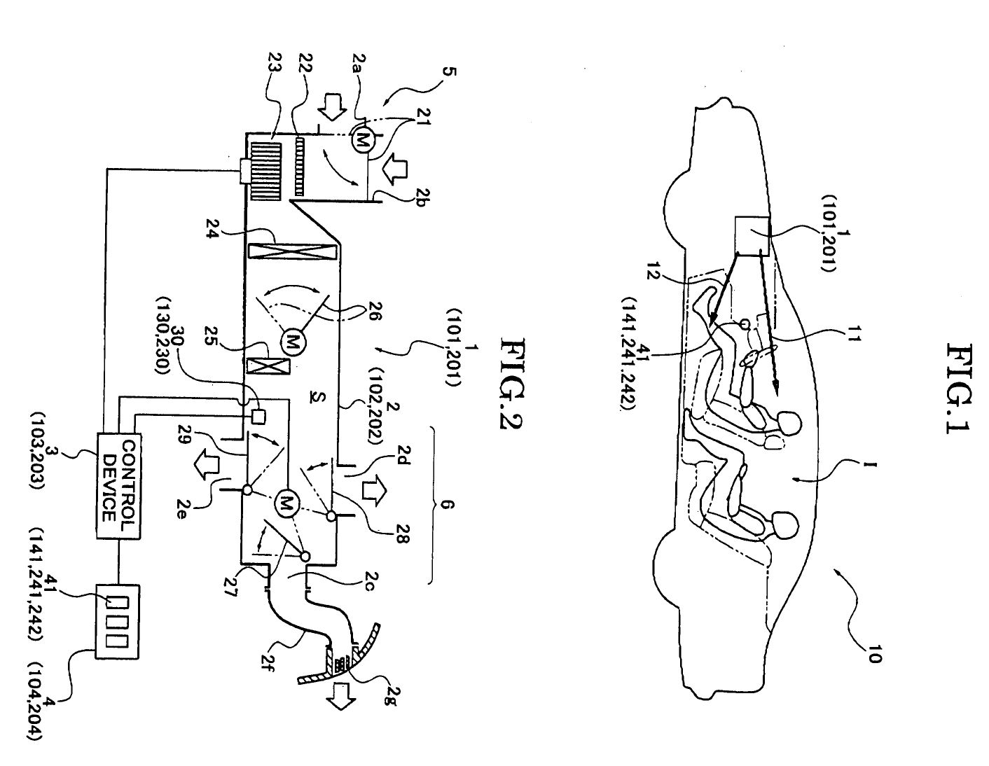

An air conditioner for a vehicle according to a first embodiment of the present invention will be described with reference to FIGS. 1 and 2. FIG. 1 is a schematic side view in section illustrating a vehicle 10 in which an air conditioner 1 for the vehicle according to the first embodiment of the present invention is used. FIG. 2 is a schematic configuration diagram illustrating the air conditioner 1 for the vehicle. The air conditioner according to the embodiment of the present invention is configured to condition air in a vehicle room of the vehicle 10 by sending air-conditioned air to the vehicle room. The air conditioner 1 includes a body 2 and a control device 4. The body has a suction port 5 including an inside air inlet 2a and an outside air inlet 2b and a blowout port 6. The air conditioner also includes an intake door 21 configured to close one of the inside air inlet 2a and the outside air inlet 2b, a fan 23 configured to take inside air from the inside air inlet 2a when the intake door 21 closes the outside air inlet 2b and outside air from the outside air inlet 2b when the intake door 21 closes the inside air inlet 2a and to send the taken inside or outside air through the blowout port 6 to the vehicle room as the air-conditioned air. That is, the fan is configured to take into the body the inside or outside air from the suction port 5 in which the outside air inlet 2b or the inside air inlet 2a is closed and to send the taken inside or outside air through the blowout port 6 to the vehicle room as the air-conditioned air.

The body 2 is formed in a case-like form and the inside air inlet 2a and the outside air inlet 2b are provided on an upstream end of the body 2. These inlets 2a, 2b form the suction port 6. The inside air inlet 2a is used to take air inside of the vehicle room, that is, inside air. The outside air inlet 2b is used to take air outside of the vehicle room, that is, outside air. In an inside S of the body 2, the intake door 21 is disposed adjacent to both of the inside air inlets 2a and the outside air inlet 2b. The intake door 21 is driven by a motor M in a direction shown by an arrow in FIG. 2 so that the inside air inlet 2a and the outside air inlet 2b are switched to be opened or closed.

In the inside S of the body 2, a filter 22, an evaporator 24 as a heat exchanger for cooling, and a heater core 25 as a heat exchanger for heating are provided.

The filter 22 is provided at a downstream side of the inside and outside air inlets 2a, 2b. The fan 23 is provided at a downstream side of the filter 22. The fan 23 is used to take air and send the taken air to the downstream side of the fan 23. The evaporator 24 is provided at a downstream side of the fan 23 and used to cool the air sent from the fan 23. The heater core 25 is provided at a downstream side of the evaporator 24 and used to heat the air sent from the fan 23 by passing warm water such as engine cooling water inside thereof.

In the inside S of the body 2, an air mixing door 26 is provided between the evaporator 24 and the heater core 25 and used to adjust an amount of the air sent to the heater core 25 by driving a motor M in a direction shown by an arrow in FIG. 2.

The blowout port 6 is provided at a downstream side of the body 2. The blowout port 6 includes at least three outlets, that is, a face opening 2c, a defroster opening 2d, and a foot opening 2e.

The face opening 2c is connected to a face outlet 2g. The face outlet 2g is disposed toward a front seat on an instrument panel. The defroster opening 2d is connected to a not-shown defroster outlet via a not-shown defroster duct. The defroster outlet is disposed toward an inner surface of a front window of the vehicle on the instrument panel. The foot opening 2e is connected to a not-shown foot outlet via a not-shown foot duct. The foot outlet is disposed at the foot side of the front seat.

In the inside S of the body 2, doors 27 to 29 for the outlets are provided. More particularly, the face door 27, the defroster door 28, and the foot door 29 are provided. The face door 27 is configured to close the face opening 2c, the defroster door 28 is configured to close the defroster opening 2d, and the foot door 29 is configured to close the foot opening 2e. Each door 27 to 29 is driven by a motor M to open or close each opening 27 to 29.

The air conditioner 1 further includes a component emitting device 30 such as an ion generating device provided in the body 2. The component emitting device 30 is configured to emit air including a desired component such as minus ion or negative ion in the body 2 while the fan 23 is driven to send the emitted desired air to the vehicle room with the air-conditioned air. In this embodiment, the component emitting device is disposed between the fan 23 and the blowout port 6, more particularly, at the upstream side of the three openings 2d to 2f. The control device 3 is configured to close the outlet air inlet 2b by the intake door 21 while the component emitting device 30 emits the air including the desired component.

The ion generating device 30 as the component emitting device is configured to generate and emit at least first component air, which includes a first component such as minus ion, and second component air, which includes a second component such as plus ion or positive ion The first component air is referred to as the minus ion air and the second component air is referred to as the plus ion air.

The ion generating device 30 may be configured to generate and emit minus ion and plus ion from water molecules and oxygen molecules in environmental air by plasma discharge.

The control device 3 is configured to switch between a first mode in which the ion generating device 30 generates and emits the minus ion air and a second mode in which the ion generating device 30 generates and emits the plus ion air every predetermined time, for example, 15 minutes. The control device 3 is configured to close the outside air inlet 2b or the inside air inlet 2a by the intake door 31 during the first or second mode.

The ion generating device 30 is disposed adjacent to the foot opening 2e at the upstream side thereof. The ion generating device is only required to be disposed between the heater core 25 and the two openings 2d, 2e. The ion generating device 30 is conventionally used. The ion generating device 30 is configured to switch to generate and emit the minus ion air and the plus ion air every predetermined time, for example, 15 minutes.

The switching of the generation of the minus ion air and the plus ion air can be controlled by the control device 3. The control device 3 is configured to close the outside air inlet 2b by the intake door 21 during the first mode, that is, a minus ion mode. The ion generating device 30 can be configured to generate and emit the plus ion air when the ion generating device 30 starts to be driven before the minus ion air.

The effect of the plus ion and the minus ion will be explained. The effect of the plus ion is a bacteria elimination effect, or the like. That is, it is expected to reduce fungus in the vehicle room, bacteria such as viruses, pollen, cigarette smoke, or the like. On the other hand, as the effect of the minus ion, it is expected to adjust the ion balance in the vehicle room to be that of a natural environment.

The control device 3 is configured to control operations in the air conditioner 1. The control device 3 includes a CPU, a ROM in which operational procedures, various data, and the like are stored, a RAM in which data during operation are stored, a timer, and the like.

An operation unit 4 is connected to an input terminal of the control device 3. The operation unit 4 is provided on the instrument panel. Various switches 41 are provided on the operation unit 4. The various switches 41 are, for example, a start switch of the air conditioner 1, a selection switch of air conditioning modes, a start switch of the ion generating device 30, and the like.

The control device has output terminals, which are connected to the fan 23, the evaporator 24, the heater core 25, and the ion generating device 30. The output terminals are also connected to the motor M, which drives the intake door 21, the motor M, which drives the air mixing door 26, and the motor M, which drives the doors 27 to 29. Thereby, the control device 3 is configured to control the operations of the various devices 23 to 25 and 30, and the operations to open and close the various doors 21 and 26 to 29.

Next, normal operations of the air conditioner 1 will be explained. The operations are started by turning on the start switch 41 of the operation unit 4.

At first, a case where an air conditioning mode is a cooling mode and the intake door 21 closes the inside air inlet 2a, that is, the suction port 5 is in an outside mode will be described. When the cooling mode and the outside mode arc selected, the control device 3 judges whether or not the suction port 5 is set in the outside mode, that is, in a state where the outside air is capable of entering through the outside air inlet 2b. If the control device 3 judges that the suction port 5 is in an inside mode, that is, in a state where the intake door 21 closes the outside air inlet 2b and therefore the inside air is capable of entering through the inside air inlet 2a, the intake door 21 is driven to close the inside air inlet 2a. Thereby, the suction port 5 is set to the outside mode.

Next, the control device 3 judges whether or not the face opening 2c is opened. If the control device 3 judges that the face opening 2c is closed, the face door 27 is driven to open the face opening 2c. Thereby, the face outlet 2g is set in an opened state.

The control device 3 judges whether or not the defroster opening 2d is opened. If the control device 3 judges that the defroster opening 2d is opened, the defroster door 28 is driven to open the defroster opening 2d. Thereby, the defroster opening 2d is set in an opened state.

The control device 3 judges whether or not the foot opening 2e is opened. If the control device 3 judges that the foot opening 2e is opened, the foot door 29 is driven to close the foot opening 2e. Thereby, the foot opening 2e is set in a closed state.

Then, the control device 3 drives the fan 23 and the evaporator 24. The fan 23 is driven so that the air outside the vehicle room, that is, the outside air is taken from the outside air inlet 2b into the inside S of the body 2 of the air conditioner 1. The air taken in the inside S passes through the filter 22 and is sent to the evaporator 24. The air sent to the evaporator 24 is cooled. The cooled air is blown out to the vehicle room 1 as cooled-conditioned air 11 as shown in FIG. 1. More particularly, the cooled conditioned air 11 is blown out from the face outlet 2g toward a head of an occupant on the front seat or blown out from the defroster outlet toward the inner surface of the front window of the vehicle.

Next, a case where the air conditioning mode is the cooling mode and the intake door 21 closes the outside air inlet 2b, that is, the suction port 5 is in an inside mode will be described. If the cooling mode and the inside mode are selected, the control device 3 judges whether or not the suction port 5 is set in the inside mode, that is, in a state where the inside air is capable of entering through the inside air inlet 2a. If the control device 3 judges that the suction port 5 is set in the outside mode, that is, the intake door 21 closes the inside air inlet 2a, the intake door 21 is driven to close the outside air inlet 2b. Thereby, the suction port 5 is set in the inside mode.

The control device 3 drives the fan 23 and the evaporator 24. The fan 23 is driven so that the inside air is taken from the inside air inlet 2a into the inside S of the body 2 of the air conditioner 1. The air taken into the inside S passes through the filter 22 and is sent to the evaporator 24 so that the air is cooled. The cooled air is blown out into the vehicle room I as cooled conditioned air 11 as shown in FIG. 1. A position where the cooled conditioned air 11 is blown out is the same as that in the case of the outside mode.

A case where the air conditioning mode is a heating mode and the suction port 5 is set in the outside mode will be described. If the heating mode and the outside mode are selected, the control device 3 judges whether or not the suction port 5 is set in the outside mode. If the control device 3 judges that the suction port 5 is set in the inside mode, the intake door 21 is driven to close the inside air inlet 2a. Thereby the suction port 5 is set in the outside mode.

The control device 3 judges whether the face opening 2c is opened or closed. If the control device 3 judges that the face opening 2c is opened, the face door 27 is driven to close the face opening 2c. Thereby, the face outlet 2g is set in a closed state.

The control device 3 judges whether the defroster opening 2d is opened or closed. If the control device 3 judges that the defroster opening 2d is closed, the defroster door 29 is driven to open the defroster opening 2d. Thereby, the defroster opening 2d is set in an opened state.

The control device 3 judges whether the foot opening 2e is opened or closed. If the control device 3 judges that the foot opening 2e is closed, the foot door 29 is driven to open the foot opening 2e. Thereby, the foot opening 2e is set in an opened state.

The control device 3 drives the air mixing door 26. Thereby, the air mixing door 26 is disposed in a predetermined position, for example, a position shown by a solid line in FIG. 2 in accordance with a temperature set to heat the inside of the vehicle room.

Then, the control device 3 drives the fan 23 and the heater core 25. The fan 23 is driven so that the outside air is taken from the outside air inlet 2b into the inside S of the body 2. The air taken in the inside S passes through the filter 22 and is sent to the heater core 25. The air sent to the heater core 25 is heated. The heated air is blown out into the inside I of the vehicle room as heated conditioned air 12 as shown in FIG. 1. More particularly, the heated conditioned air 12 is blown out from the foot outlet toward the foot side of the occupant on the front seat or is blown out from the defroster outlet toward the inner surface of the front window of the vehicle.

Next, a case where the air conditioning mode is the heating mode and the suction port 5 is in the inside mode will be described. If the heating mode and the inside mode are selected, the control device 3 judges whether or not the suction port 5 is set in the inside mode. If the control device 3 judges that the suction port 5 is set in the outside mode, the intake door 21 is driven to close the outside air inlet 2b. Thereby, the suction port 5 is set in the inside air inlet 2a.

Then, the control device 3 drives the fan 23 and the heater core 25. The fan 23 is driven so that the inside air is taken from the inside air inlet 2a into the body 2 of the air conditioner 1. The taken air passes the filter 22 and is sent to the heater core 26 so that the air sent to the heater core 26 is heated. The heated air is blown out into the inside I of the vehicle room as heated conditioned air as shown in FIG. 1. A position where the heated air is blown out is the same as that in the case of the outside mode.

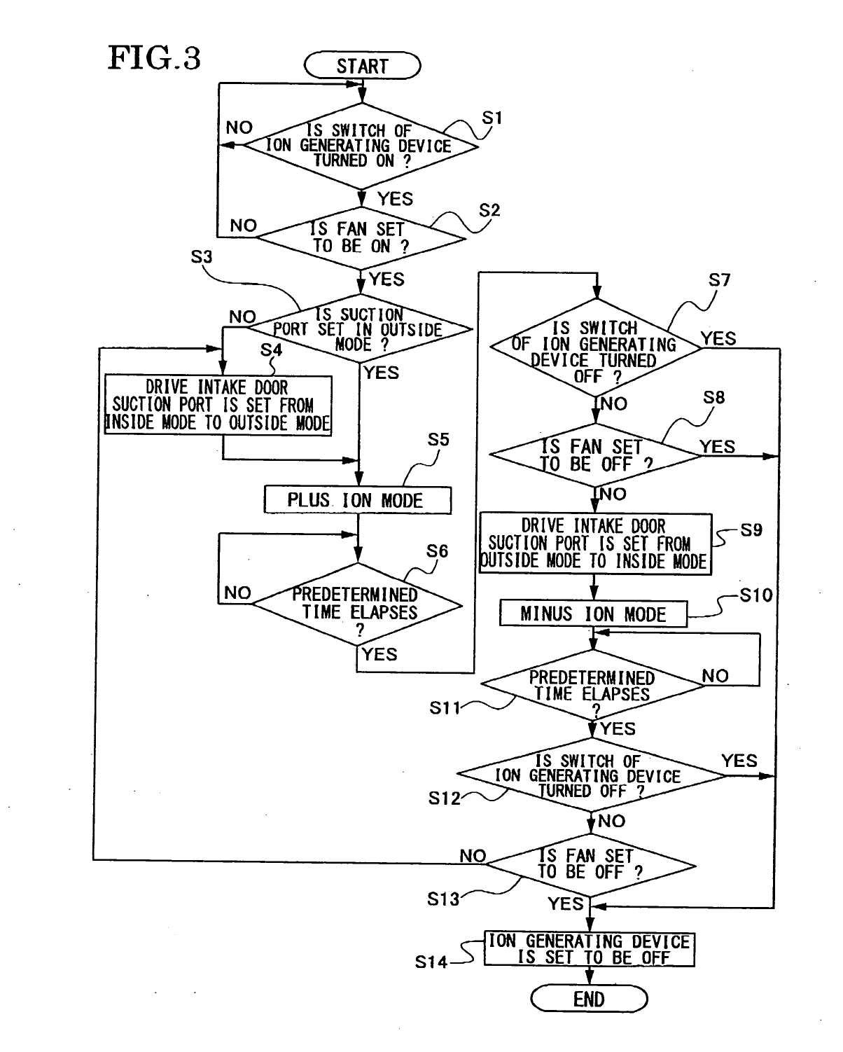

Next, a control operation of the control device 3 when driving the ion generating device 30 will be described with reference to a flowchart shown in FIG. 3. The control operation is started when the start switch 41 of the ion generating device 30 is turned on by the occupant.

The control device 3 judges whether or not the start switch 41 of the ion generating device is turned on (step S1). If the control device 3 judges that the start switch 41 is turned on, that is, when the judged result is “YES” in step S1, the control device 3 judges whether or not the fan 23 is driven (step S2). The control device 3 repeats both operations until both judged results in steps S1 and S2 become “YES”.

If the control device 3 judges that the fan 23 is driven, that is, when the judged result is “YES” in step S2, the control device 3 judges whether or not the suction port 5 is set in the outside mode where the intake door 21 closes the inside air inlet 2a (step S3). If the control device 3 judges that the suction port 5 is set in the inside mode where the outside air inlet is closed by the intake door 21, that is, when the judged result is “NO” in step S3, the intake door 21 is driven to close the inside air inlet 2a so that the suction port 6 is set in the outside mode (step S4).

If the control device 3 judges that the suction port 5 is set in the outside mode, that is, when the judged result is “YES” in step S3, or if the suction port 5 is set in the outside mode, the control device 3 drives the ion generating device 30. At this time, a generating mode of the ion generating device 30 is in a plus mode (step S5). Thereby, the ion generating device 30 generates and emits air including plus ion, which is referred to as the plus ion air, into the inside S of the body 2 of the air conditioner. The plus ion air is blown out into the inside I of the vehicle room with the air-conditioned air such as the cooled or heated conditioned air 11, 12 as shown in FIG. 1. The air may include both of the minus ion and the plus ion.

The control device 3 judges whether or not the predetermined time, for example, 15 minutes has elapsed from the start of the plus ion mode (step S6). If the control device 3 judges that the predetermined time has elapsed from the start of the plus ion mode, that is, when the judged result is “YES” in step S6, the control device 3 judges whether or not the start switch 41 of the ion generating device 30 is turned off (step S7). If the control device 3 judges that the start switch 41 is turned off, that is, when the judged result is “YES” in step S7, the control device 3 stops driving the ion generating device 30 (step S 14).

If the control device 3 judges whether the start switch 41 of the ion generating device 30 is kept turned on, that is, when the judged result is “NO” in step S7, the control device 3 judges whether or not the fan 23 is set to be off (step S8). If the control device 3 judges that the fan is set to be off, that is, when the judged result is “YES” in step S8, the control device 3 stops driving the ion generating device 30 (step S14).

If the control device 3 judges that the fan 23 is set to be on, that is, when the judged result is “NO” in step S8, the intake door 21 is driven to close the outside air inlet 2b (step S9). Thereby, the suction port 5 is set in the inside mode. The control device 3 sets the generating mode of the ion generating device 30 to the minus ion mode (step S10). Thereby, the ion generating device 30 generates and emits the air including the minus ion into the inside S of the body 2 of the air conditioner 1. The air including the minus ion, which is referred to as the minus ion air, is blown out to the inside I of the vehicle room with the air-conditioned air such as the cooled-conditioned air 11 or the heated-conditioned air 12.

The control device 3 judges whether or not the predetermined time, for example, 15 minutes has elapsed from the start of the minus ion mode (step S11). If the control device 3 judges that the predetermined time has elapsed from the start of the minus ion mode, that is, when the judged result is “YES” in step S11, the control device 3 judges whether or not the start switch 41 is set to be off (step S12). If the control device 3 judges that the start switch 41 is set to be off, that is, when the judged result is “YES” in step S12, the control device 3 stops driving the ion generating device 30 (step S14).

If the control device 3 judges that the start switch 41 of the ion generating device 30 is turned on, that is, when the judged result is “NO” in step S12, the control device 3 judges whether or not the fan 23 is set to be off (step S13). If the control device 3 judges that the fan 23 is set to be off, that is, when the judged result is “YES” in step S13, the control device 3 stops driving the ion generating device 30 (step S14).

If the control device 3 judges that the fan 23 is set to be on, that is, when the judged result is “NO” in step S 13, the intake door 21 is driven to close the inside air inlet 2a (step S4). Thereby, the suction port 5 is set in the outside mode. Next, the control device 3 performs the operations of the steps S5 to S13. As mentioned above, the control device 3 repeatedly performs the operations of steps S4 to S13 until the start switch 41 of the ion generating device 30 is turned off or the fan 23 is set to be off.

As mentioned above, the air conditioner 1 for a vehicle according to this embodiment is configured to switch the plus ion mode where the plus ion is blown out and the minus ion mode where the minus ion is blown out to the inside I of the vehicle room every predetermined time, for example, 15 minutes. Furthermore, in the air conditioner 1, the intake door 21 is set to close the outside air inlet 2b and to open the inside air inlet 2a while the minus ion air is generated and emitted.

Thereby, the air conditioner 1 generates and emits the minus ion air in a state where only the inside air is circulated while intercepting the outside air so that it is expected to increase the concentration of the minus ion in the inside I of the vehicle room with time. Accordingly, the air conditioner 1 for a vehicle can effectively provide a good effect caused by the minus ion to the occupant and the air conditioner 1 according to this embodiment of the present invention can provide a more comfortable feeling to the occupant than the conventional air conditioner.

Furthermore, in the air conditioner 1 according to this embodiment of the present invention, the suction port 5 is set in the outside mode by the intake door 21 while the plus ion air is generated and emitted. Thereby, the air conditioner 1 is configured to keep the plus ion in the inside I of the vehicle room as well as being configured to increase the concentration of the minus ion in the inside I of the vehicle room. Therefore, the air conditioner 1 can effectively provide an effect from the minus ion and from the plus ion to the occupant to effectively provide a more comfortable feeling to the occupant.

In the air conditioner 1 according to this embodiment, the plus ion air is generated and emitted by the ion generating device 30 at the beginning of the operations. Thereby, in the air conditioner 1, it is possible to perform sterilization in the inside I of the vehicle room at the beginning of the operation of the ion generating device 30. Accordingly, in the air conditioner 1 according to this embodiment, it is possible to increase the comfort feeling to the occupant.

In addition, the predetermined time to switch the plus ion mode and the minus ion mode of the ion generating device 30 is not limited and the predetermined time to switch from the plus ion mode to the next minus ion mode at the beginning of the operation of the ion generating device 30 can be set to longer than the following switching predetermined time, for example, the predetermined time at the beginning of the operation can be set to 30 minutes. In this case, the effect of the sterilization of the inside I of the vehicle room can be enhanced.

### Second Embodiment

Next, an air conditioner 101 for a vehicle according to the second embodiment will be explained.

Configurations of the air conditioner 101 for a vehicle according to the second embodiment are basically the same as those of the air conditioner 1 for a vehicle according to the first embodiment and the air conditioner according to this embodiment will be explained with reference to FIGS. 1 and 2. The same reference numbers are attached to the same parts as those of the first embodiment and the parts different from the first embodiment will be mainly described.

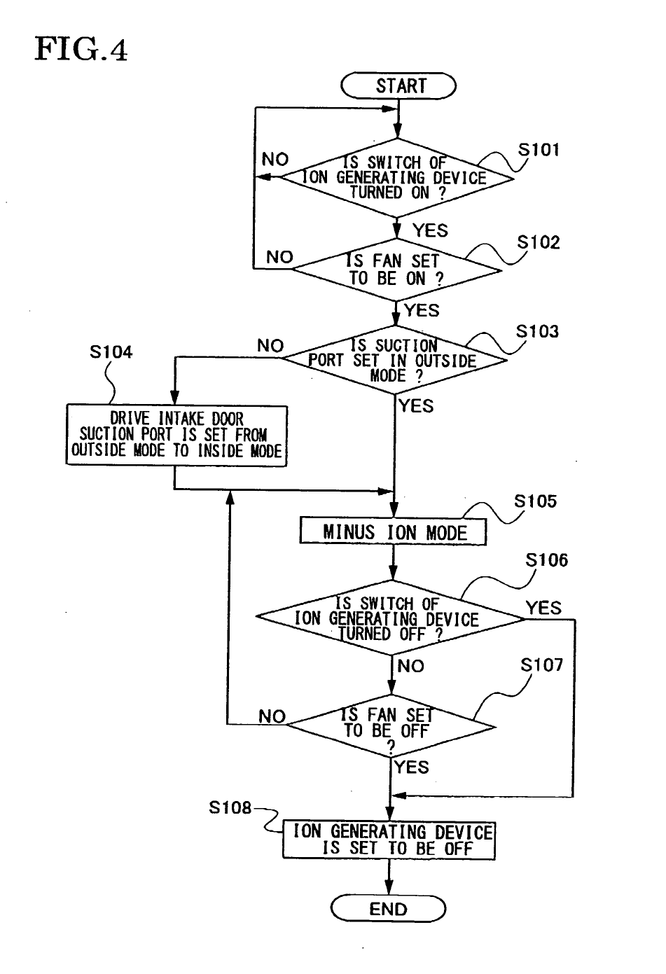

In the schematic view of the air conditioner 101 as shown in FIG. 2, there is a difference in that an ion generating device 130 is configured to generate and emit only the minus ion. Control operations by a control device 103 in this case will be explained with reference to a flowchart shown in FIG. 4.

The control operation is started when the occupant turns on a start switch 141 of the ion generating device 130 on an operation unit 104. At first, the control device 103 judges whether or not the start switch 141 is turned on (step S101). If the control device 103 judges that the start switch 141 is turned on, that is, when the judged result is “YES” in step S101, the control device 103 judges whether or not the fan 23 is driven (step S102). The control device 103 repeatedly performs both operations in steps S101 and S102 until both judged results become “YES”.

If the control device 103 judges that the fan 23 is driven, that is, when the judged result is “YES” in step S102, the control device 103 judges whether or not the suction port 5 is set in the inside mode (step S103). If the control device 103 judges that the suction port 5 is set in the outside mode, that is, when the judged result is “NO” in step S103, the intake door 21 is driven to close the outside air inlet 2b so that the suction port 5 is set in the inside mode (step S104).

If the control device 103 judges that the suction port 5 is set in the inside mode, that is, when the judged result is “YES” in step S103 or the suction port 5 is set in the inside mode by the operation in step S104, the control device 103 drives the ion generating device 130. At this time, the generating mode of the ion generating device 130 is in the minus ion mode (step S105). Thereby, the ion generating device 130 generates and emits the air including the minus ion, which is referred to as the minus ion air, into the inside S of a body 102 of the air conditioner 101. The minus ion air is blown out into the inside I of the vehicle room with the air-conditioned air such as the cooled-conditioned air 11 or the heated-conditioned air 12, as shown in FIG. 1.

Next, the control device 103 judges whether or not the start switch 141 of the ion generating device 130 is turned off by the occupant (step S106). If the control device 103 judges that the start switch 141 is turned off, that is, when the judged result is “YES” in step S106, the control device 103 stops to the driving of the ion generating device 130 (step S108).

If the control device 103 judges whether or not the start switch 141 of the ion generating device 130 is kept on, that is, when the judged result is “NO” in step S106, the control device 103 judges whether or not the fan 23 is set to be OFF (step S107). If the control device 103 judges that the fan 23 is set to be OFF, that is, the judged result is “YES” in step S107, the control device 103 stops the driving of the ion generating device 130 (step S108).

If the control device 103 judges that the fan 23 is kept ON, that is, when the judged result is “NO” in step S107, the control device 103 maintains the driving of the ion generating device 130. As mentioned above, the control device 103 repeatedly performs the operations of steps S105 to S107 until the start switch 141 of the ion generating device 130 is turned off or the fan 23 is set to be OFF.

As mentioned above, in the air conditioner 101 according to this embodiment, the intake door 21 is set to close the outside air inlet 2b, that is, the suction port 5 is set in the inside mode while the minus ion air is generated and emitted. Thereby, the air conditioner 101 is configured to circulate only the inside air by intercepting the outside air while the minus ion air is generated and emitted so that the concentration of the minus ion in the inside I of the vehicle room increases with time. Accordingly, the air conditioner 101 according to this embodiment can effectively provide the effect from the minus ion to the occupant so that the air conditioner 101 can provide a more comfortable feeling to the occupant than the conventional air conditioner.

### Third Embodiment

Next, an air conditioner 201 for a vehicle according to the third embodiment will be explained.

Configurations of the air conditioner 201 for a vehicle according to the third embodiment are basically the same as those of the air conditioner 1 for a vehicle according to the first embodiment and the air conditioner according to this embodiment will be explained with reference to FIGS. 1 and 2. The same reference numbers are attached to the same parts as those of the first embodiment and the parts different from the first embodiment will be mainly described.

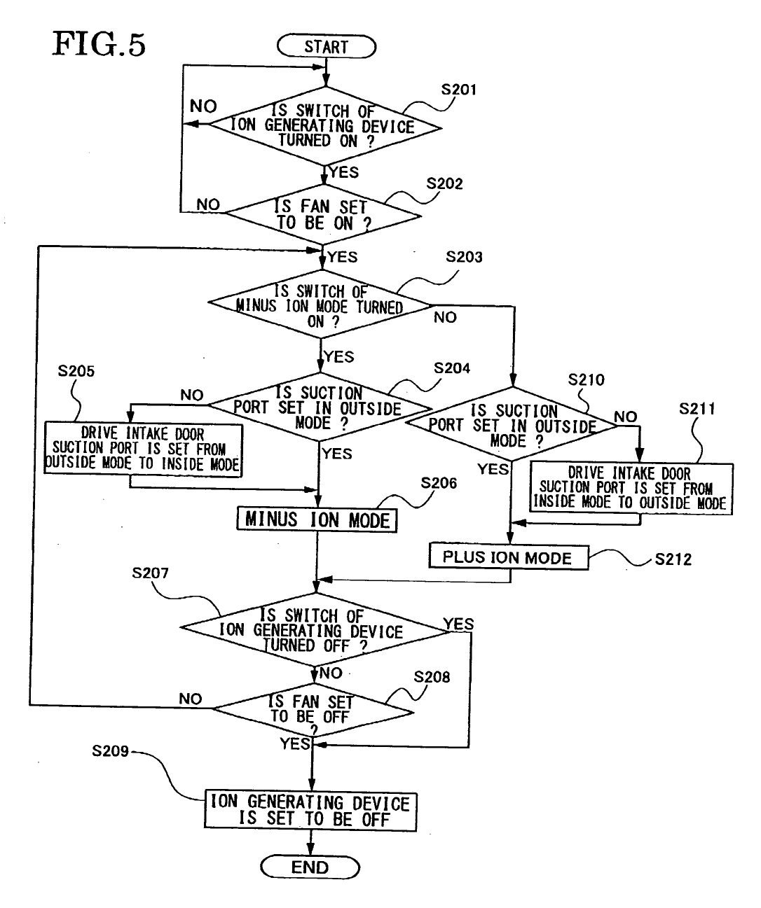

In the schematic view of the air conditioner 201 shown in FIG. 2, there is a difference from the air conditioner 1, in that switches 242 of the generating mode including the minus ion mode switch and the plus ion mode switch of an ion generating device 230 is provided. Thereby, the minus ion mode and the plus ion mode can be selected by the occupant. The control operations of a control device 203 in this case will be explained with reference to a flowchart shown in FIG. 5.

The control operation is started when the occupant turns on a start switch 241 of the ion generating device 230. At first, the control device 203 judges whether or not the start switch 241 is turned on (step S201). If the control device 203 judges that the start switch 241 is turned on, that is, when the judged result is “YES” in step S201, the control device 203 judges whether or not the fan 23 is driven (step S202). The control device 203 repeatedly performs the operations of steps S201 and S202 until the judged results of both steps are “YES”.

If the control device 203 judges that the fan 23 is driven, that is, when the judged result is “YES” in step S202, the control device 203 judges whether or not the minus mode switch 242 of the ion generating device 230 is turned on (step S203). If the control device judges that the minus ion mode switch 242 is turned on, that is, when the judged result is “YES” in step S203, the control device 203 judges whether or not the suction port 5 is set in the inside mode (step S204). If the control device 203 judges that the suction port 5 is set in the outside mode, that is, when the judged result is “NO” in step S204, the intake door 21 is driven to close the outside air inlet 2b so that the suction port 5 is set in the inside mode (step S205).

If the control device 203 judges that the suction port 5 is set in the inside mode, that is, when the judged result is “YES” in step S204 or the suction port 5 is set in the inside mode by the operation in step S205, the control device 203 drives the ion generating device 230 in the minus ion mode (step S206). Thereby, the ion generating device 230 generates and emits the minus ion air in the inside S of a body 202 of the air conditioner 201. The minus ion air is blown out into the inside I of the vehicle room with the air-conditioned air such as the cooled-conditioned air 11 or the heated-conditioned air 12 as shown in FIG. 1

Next, the control device 203 judges whether or not the start switch 241 of the ion generating device 230 is turned off by the occupant during the driving of the ion generating device 230 (step S207). If the control device 203 judges that the start switch 241 is turned off, that is, when the judged result is “YES” in step S207, the control device 203 stops the driving of the ion generating device 230 (step S209).

If the control device 203 judges that the start switch 241 is kept ON, that is, when the judged result is “NO” in step S207, the control device 203 judges whether or not the fan 23 is set to be OFF (step S208). If the control device 203 judges that the fan 23 is set to be OFF, that is, when the judged result is “YES” in step S208, the control device 203 stops the driving of the ion generating device 230 (step S209). If the control device 203 judges that the fan 23 is kept ON, that is, when the judged result is “NO” in step S208, the flow of the operations proceeds to step S203.

On the other hand, if the control device 203 judges that the minus ion mode switch 242 of the ion generating device 230 is set to be OFF and thereby the plus ion mode switch 242 is set to be ON, that is, when the judged result is “NO” in step S203, the control device 203 judges whether or not the suction port 5 is set in the outside mode (step S210). If the control device 203 judges that the suction port 5 is set in the inside mode, that is, when the judged result is “NO” in step S210, the intake door 21 is driven to close the inside air inlet 2a so that the suction port 5 is set in the outside mode (step S211).

If the control device 203 judges that the suction port 5 is set in the outside mode, that is, when the judged result is “YES” in step S210 or if the suction port 5 is set in the outside mode by the operation in step S211, the control device 203 drives the ion generating device 230 in the plus ion mode (step S212). Thereby, the ion generating device 230 generates and emits the plus ion air into the inside S of the body 202 of the air conditioner 201. The plus ion air is blown out into the inside I of the vehicle room with the air-conditioned air such as the cooled-conditioned air 11 or the heated-conditioned air 12 as shown in FIG. 1.

Next, the control device 203 performs the above-mentioned judging operations in steps S207 and S208 during the driving of the ion generating device 230. If the control device 203 judges that the start switch 241 of the ion generating device 230 is turned on and the fan 23 is set to be ON, that is, when the judged result is “NO” in step S208, the flow of the operations returns to step S203. As mentioned above, the control device 203 repeatedly performs the operations in steps S203 to S212 until the start switch 241 of the ion generating device 230 is turned off or the fan 23 is set to be OFF.

As mentioned above, in the air conditioner 201 for a vehicle according to this embodiment, the suction port 5 is set in the inside mode while the minus ion air is generated and emitted. Thereby, the air conditioner 201 is configured to generate and emit the minus ion air in a state where only the inside air is circulated while the outside air is intercepted, so that the concentration of the minus ion in the inside I of the vehicle room increases with time. Accordingly, the air conditioner 201 according to this embodiment can effectively provide an effect obtained from the minus ion to the occupant so that a more comfortable feeling than the conventional air conditioner can be provided.

Furthermore, in the air conditioner 201, the suction port 5 is set in the outside mode while the plus ion air is generated and emitted. Thereby, the air conditioner 201 can increase the concentration of the minus ion in the inside I of the vehicle room and also maintain an appropriate level of the plus ion in the inside I of the vehicle room. Accordingly, the air conditioner 201 can effectively provide an effect obtained from the minus ion and the plus ion so that a comfortable feeling to the occupant can be increased more than with the conventional air conditioner.

In the first to third embodiments, the ion generating device 30, 130, or 230 which generates and emits the plus ion air and the minus ion air is used as the component emitting device. However, a component emitting device which emits air including a desired or beneficial component for the occupant such as Plasmacluster® ion, or the like can be used. In the case of the air conditioner having such a component emitting device, the suction port 5 is set in the inside mode so that the concentration of the desired component can be increased in the inside of the vehicle room with time. Accordingly, such an air conditioner can provide a more comfortable feeling to the occupant than the conventional air conditioner.

Although the present invention has been described in terms of exemplary embodiments, it is not limited thereto. It should be appreciated that variations may be made in the embodiments described by persons skilled in the art without departing from the scope of the present invention as defined by the following claims.

### Industrial Applicability

As mentioned above, with the air conditioner according to an embodiment of the present invention, it is possible to increase the comfort feeling for an occupant in a vehicle room by use of air including a desired component for the occupant. Accordingly, the air conditioner according to the present invention can be used to effect in the technical fields of air conditioners for vehicles.

According to the configurations, the air conditioner according to an embodiment of the present invention is configured to generate and emit air including a desired component for the occupant in a state where only the inside air is circulated by intercepting the outside air so that the concentration of the desired component in the vehicle room increases with time.

Due to the above-mentioned configurations, in the air conditioner according to an embodiment of the present invention, the concentration of the minus ion in the vehicle room can be increased.

In the air conditioner according to an embodiment, the concentration of the minus ion in the vehicle room can be increased whilst an appropriate level of plus ion remains in the vehicle room.

The air conditioner according to an embodiment of the present invention can perform sterilization of the vehicle room by use of the plus ion at the beginning of the operation of the ion generating device.

What is claimed is:

1. An air conditioner for a vehicle, which conditions air in a vehicle room of the vehicle by sending air-conditioned air to the vehicle room, comprising:
a body which has a suction port including an inside air inlet and an outside air inlet and a blowout port;
an intake door configured to close one of the inside air inlet and the outside air inlet;
a fan configured to take into the body inside or outside air from the suction port in which the outside air inlet or the inside air inlet is closed and to send the taken inside or outside air through the blowout port to the vehicle room as the air-conditioned air;
a component emitting device provided in the body, the component emitting device being configured to emit air including a desired component in the body while the fan is driven to send the emitted desired air to the vehicle room with the air-conditioned air; and
a control device configured to close the outlet air inlet by the intake door while the component emitting device emits the air including the desired component.

2. The air conditioner for a vehicle according to claim 1, wherein the blowout port includes at least three outlets; and
the component emitting device is disposed between the fan and the three outlets.

3. The air conditioner for a vehicle according to claim 1, wherein the component emitting device is configured to emit at least first component air which includes a first component and second component air which includes a second component; and
the control device is configured to switch between a first mode in which the component emitting device emits the first component air and a second mode in which the component emitting device emits the second component air every predetermined time.

4. The air conditioner for a vehicle according to claim 3, wherein the control device is configured to close the outside air inlet or the inside air inlet by the intake door during the first or second mode.

5. The air conditioner for a vehicle according to claim 1, wherein the component emitting device is an ion generating device which generates and emits at least air including minus ion.

6. The air conditioner for a vehicle according to claim 5, wherein the ion generating device is configured to generate and emit air including plus ion and the air including the minus ion;
the control device is configured to switch between a plus ion mode in which the ion generating device generates and emits the plus ion air and a minus ion mode in which the ion generating device generates and emits the minus ion air every predetermined time, and to close the inside air inlet by the intake door during the plus ion mode.

7. The air conditioner for a vehicle according to claim 6, wherein the ion generating device is configured to generate and emit the air including the plus ion when the ion generating device starts to be driven before the air including the minus ion.

8. The air conditioner for a vehicle according to claim 1, wherein the component emitting device is an ion generating device configured to generate and emit minus ion and plus ion from water molecules and oxygen molecules in environmental air by plasma discharge.
